(19) United States
(12) Patent Application Publication
(10) Pub. No.: US 2025/0115740 A1
(43) Pub. Date: Apr. 10, 2025

(54) RUBBER COMPOSITION FOR PNEUMATIC TIRES, VULCANIZED RUBBER, AND PNEUMATIC TIRE

(71) Applicant: Toyo Tire Corporation, Itami-shi (JP)

(72) Inventor: Taiki Iwachi, Itami-shi (JP)

(73) Assignee: Toyo Tire Corporation, Itami-shi (JP)

(21) Appl. No.: 18/885,896

(22) Filed: Sep. 16, 2024

(30) Foreign Application Priority Data
Oct. 10, 2023 (JP) 2023-175187

(51) Int. Cl. C08K 7/02; B60C 1/00; C08J 3/24; C08K 3/04; C08L 1/16

(52) U.S. Cl. CPC C08K 7/02; B60C 1/0016; B60C 1/0025; C08J 3/247; C08K 3/04; C08L 1/16; C08J 2301/16; C08J 2307/00; C08K 2201/011

(57) ABSTRACT

A rubber composition for pneumatic tires comprising a diene-based rubber, carbon black, and phosphoric acid-modified cellulose nanofiber. It is preferred that the cellulose nanofiber is contained in an amount of 0.1 to 50 parts by mass per 100 parts by mass of an entire amount of the diene-based rubber. It is preferred that the carbon black is contained in an amount of 1 to 80 parts by mass per 100 parts by mass of an entire amount of the diene-based rubber. It is preferred that when a content of the carbon black and a content of the cellulose nanofiber per 100 parts by mass of an entire amount of the diene-based rubber are respectively defined as X and Y, X+Y<80 and 0.05<(Y/(X+Y)<0.5 are satisfied.

### BACKGROUND OF THE INVENTION

### Field of the Invention

The present invention relates to a rubber composition for pneumatic tires, a vulcanized rubber, and a pneumatic tire including the vulcanized rubber as a rubber part.

### Description of the Related Art

A general method for improving the durability of a pneumatic tire is to increase the rubber strength of a rubber part of the pneumatic tire. The rubber strength may be increased by, for example, increasing the amount of a filler such as carbon black or silica, which, however, tends to deteriorate durability due to a reduction in elongation of the rubber part of the pneumatic tire.

Patent Document 1 mentioned below discloses a rubber composition containing a rubber component and fibrous cellulose, wherein an amount of a substituent introduced into the fibrous cellulose is less than 0.5 mmol/g and the fibrous cellulose has a number average fiber width of 1 to 100 nm.

### PRIOR ART DOCUMENT

### Patent Document

Patent Document 1: JP-A-2021-191841

### SUMMARY OF THE INVENTION

However, Patent Document 1 mentioned above is intended to provide a rubber composition capable of producing a rubber molded body having excellent designability and being less colored, and therefore the rubber composition does not contain carbon black that makes the rubber molded body all black and there is no description about whether or not the molded body has rubber strength appropriate for pneumatic tires.

In view of the above circumstances, it is an object of the present invention to provide a rubber composition for pneumatic tires as a raw material of a vulcanized rubber excellent in rubber strength, especially a vulcanized rubber useful as a rubber part of a pneumatic tire.

The above object can be achieved by the following aspects. Specifically, the present invention relates to a rubber composition for pneumatic tires (1) containing a diene-based rubber, carbon black, and phosphoric acid-modified cellulose nanofiber.

The rubber composition for pneumatic tires (1) is preferably a rubber composition for pneumatic tires (2), wherein the cellulose nanofiber is contained in an amount of 0.1 to 50 parts by mass per 100 parts by mass of an entire amount of the diene-based rubber.

The rubber composition for pneumatic tires (1) or (2) is preferably a rubber composition for pneumatic tires (3), wherein the carbon black is contained in an amount of 1 to 80 parts by mass per 100 parts by mass of an entire amount of the diene-based rubber.

Any one of the rubber compositions for pneumatic tires (1) to (3) is preferably a rubber composition for pneumatic tires (4), wherein when a content of the carbon black and a content of the cellulose nanofiber per 100 parts by mass of an entire amount of the diene-based rubber are respectively defined as X and Y, X+Y<80 and 0.05<Y/(X+Y)<0.5 are satisfied.

The present invention also relates to a vulcanized rubber (5) obtained by vulcanizing and molding any one of the rubber compositions for pneumatic tires (1) to (4).

The present invention also relates to a pneumatic tire (6) including the vulcanized rubber (5) as a rubber part.

The rubber composition for pneumatic tires according to the present invention is one in which carbon black and phosphoric acid-modified cellulose nanofiber are contained in a diene-based rubber. It is difficult to disperse cellulose nanofiber in a rubber component due to strong cohesive force of the cellulose nanofiber. In the present invention, however, phosphoric acid-modified cellulose nanofiber is used and the phosphoric acid-modified cellulose nanofiber is used together with carbon black, which improves dispersibility of the cellulose nanofiber in the diene-based rubber. As a result, a vulcanized rubber of the rubber composition for pneumatic tires according to the present invention has excellent rubber strength, and is therefore particularly useful as a rubber part of a pneumatic tire.

Since the rubber composition for pneumatic tires according to the present invention uses phosphoric acid-modified cellulose nanofiber, dispersibility of the cellulose nanofiber in the diene-based rubber is excellent even when the cellulose nanofiber is used together with carbon black. Therefore, even when the total amount of the carbon black and the cellulose nanofiber added is reduced to some extent, a vulcanized rubber to be finally obtained can achieve adequate elongation while maintaining rubber strength. This makes it possible to improve tensile product that is the product of “tensile strength” and “elongation percentage” of the vulcanized rubber, which is preferred because when such a vulcanized rubber is used as a rubber part of a pneumatic tire, the durability of the pneumatic tire is improved.

### DETAILED DESCRIPTION OF THE PREFERRED EMBODIMENTS

A rubber composition for pneumatic tires according to the present invention contains a diene-based rubber, carbon black, and phosphoric acid-modified cellulose nanofiber.

Examples of the diene-based rubber include natural rubber (NR), polyisoprene rubber (IR), polybutadiene (BR), polystyrene-butadiene rubber (SBR), chloroprene rubber (CR), and nitrile rubber (NBR). It should be noted that the diene-based rubber may be modified diene-based rubber. An example of the modified diene-based rubber is a diene-based rubber having a polar group, and examples of the polar group include a (meth)acrylic group and an epoxy group.

Examples of the carbon black that can be used include: carbon blacks usually used in the rubber industry, such as SAF, ISAF, HAF, FEF, and GPF; and conductive carbon blacks such as acetylene black and ketjen black. The amount of the carbon black contained in the rubber composition for pneumatic tires according to the present invention is preferably 1 to 80 parts by mass, more preferably 30 to 60 parts by mass per 100 parts by mass of the diene-based rubber.

The phosphoric acid-modified cellulose nanofiber is one obtained by introducing a phosphate group into fibrous cellulose as a substituent. For example, phosphoric acid-modified cellulose nanofiber disclosed in JP-A-2021-191841 can be used. From the viewpoint of improving the dispersibility of the phosphoric acid-modified cellulose nanofiber in the diene-based rubber and the viewpoint of improving the rubber strength of a vulcanized rubber to be finally obtained, the phosphoric acid-modified cellulose nanofiber preferably has an average fiber diameter of 1 to 100 nm and an average fiber length of 0.1 to 1000 μm. The amount of the phosphoric acid-modified cellulose nanofiber contained in the rubber composition for pneumatic tires is preferably 0.1 to 50 parts by mass, more preferably 0.5 to 10 parts by mass per 100 parts by mass of the entire amount of the diene-based rubber.

Since the rubber composition for pneumatic tires according to the present invention uses phosphoric acid-modified cellulose nanofiber, the dispersibility of the cellulose nanofiber in the diene-based rubber is excellent, and an excellent reinforcing effect is obtained. Therefore, when the cellulose nanofiber is used together with carbon black, the entire amount of a filler added (the total amount of the carbon black and the cellulose nanofiber added) can be reduced as compared to when carbon black is used alone, and therefore a vulcanized rubber to be finally obtained can achieve adequate elongation while maintaining rubber strength. In order to improve tensile product that is the product of “tensile strength” and “elongation percentage” of the vulcanized rubber, when the content of the carbon black and the content of the cellulose nanofiber per 100 parts by mass of the entire amount of the diene-based rubber are respectively defined as X and Y, X+Y<80 and 0.05<Y/(X+Y)<0.5 are preferably satisfied. X+Y is more preferably less than 40 (X+Y<40).

The rubber composition for pneumatic tires according to the present invention may contain, for example, silica as a filler in addition to the diene-based rubber, the carbon black, and the phosphoric acid-modified cellulose nanofiber.

Examples of the silica to be used include silicas usually used for rubber reinforcement, such as wet silica, dry silica, sol-gel silica, and surface-treated silica. Among these, wet silica is preferred. The amount of the silica contained in the rubber composition for pneumatic tires according to the present invention is preferably comparable with that of the carbon black.

When the silica is contained, a silane coupling agent is also preferably used. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl) tetrasulfide (e.g., “Si69” manufactured by Degussa), bis(3-triethoxysilylpropyl) disulfide (e.g., “Si75” manufactured by Degussa), bis(2-triethoxysilylethyl)tetrasulfide, bis(4-triethoxysilylbutyl)disulfide, bis(3-trimethoxysilylpropyl) tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane.

The rubber composition for pneumatic tires according to the present invention may further contain, in addition to the diene-based rubber, the carbon black, and the phosphoric acid-modified cellulose nanofiber, a vulcanization-type compounding agent, an antiaging agent, zinc oxide, stearic acid, a softener such as wax or oil, a processing aid, etc.

Examples of the vulcanization-type compounding agent include a vulcanizing agent such as sulfur or an organic peroxide, a vulcanization accelerator, a vulcanization accelerator aid, and a vulcanization retarder.

The sulfur as the vulcanization-type compounding agent is not limited as long as it is sulfur usually used for rubber, and examples of such sulfur that can be used include powdered sulfur, precipitated sulfur, insoluble sulfur, and highly-dispersible sulfur.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination of two or more of them.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

The rubber composition for pneumatic tires according to the present invention is obtained by kneading the diene-based rubber, the carbon black, the phosphoric acid-modified cellulose nanofiber, the vulcanization-type compounding agent, the antiaging agent, zinc oxide, stearic acid, the softener such as wax or oil, the processing aid, etc. with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a sulfur-based vulcanizing agent and a vulcanization accelerator are previously kneaded to prepare a master batch, the remaining component is added to the master batch, and the mixture is further kneaded, a method in which components are added in any order and kneaded, and a method in which all the components are added at the same time and kneaded.

A vulcanized rubber of the rubber composition for pneumatic tires according to the present invention is particularly excellent in rubber strength. Therefore, a pneumatic tire including a tread or a side wall constituted from a rubber part obtained by vulcanizing and molding the rubber composition for pneumatic tires according to the present invention is particularly excellent in durability.

### EXAMPLES

Hereinbelow, the configuration and effect of the present invention will be described with reference to specific examples etc. It should be noted that in examples etc., evaluation items were evaluated on the basis of the following evaluation criteria using rubber samples obtained by heating and vulcanizing rubber compositions at 150° C. for 25 minutes.

### (1) Rubber Hardness Degree

Evaluation of rubber hardness degree was performed by measuring the rubber hardness degree of an obtained vulcanized rubber test specimen at 23° C. using a type A durometer in accordance with JIS K6253. In Examples 1 to 4, the evaluation result was expressed as an index number by taking the measured value of Comparative Example 1 as 100, and in Examples 5 to 7, the evaluation result was expressed as an index number by taking the measured value of Comparative Example 2 as 100. A larger index number means that the rubber hardness degree is higher and therefore the vulcanized rubber is more excellent.

### (2) Stress at 100% Elongation

A sample of an obtained vulcanized rubber was prepared using a JIS No. 3 dumbbell, and the stress at 100% elongation (modulus M100 (MPa)) of the sample was measured in accordance with JIS K6251. In Examples 1 to 4, the evaluation result was expressed as an index number by taking the measured value of Comparative Example 1 as 100, and in Examples 5 to 7, the evaluation result was expressed as an index number by taking the measured value of Comparative Example 2 as 100. A larger index number means that the stress at 100% elongation is larger, and therefore the vulcanized rubber is more excellent.

### (3) Tensile Product

A tensile test (Dumbbell No. 3) in accordance with JIS K6251 was performed to measure tensile strength and break elongation, and the product of them was defined as tensile product. In Examples 1 to 4, the evaluation result was expressed as an index number by taking the measured value of Comparative Example 1 as 100, and in Examples 5 to 7, the evaluation result was expressed as an index number by taking the measured value of Comparative Example 2 as 100. A larger index number means that the tensile product is larger, and therefore the vulcanized rubber is more excellent.

### (Preparation of Rubber Compositions)

Rubber compositions of Examples 1 to 7 and Comparative Examples 1 and 2 were prepared according to formulations shown in Tables 1 and 2 and kneaded using a usual Banbury mixer. Compounding agents listed in Tables 1 to 2 are shown below (in Tables 1 to 2, the amount of each of the compounding agents added is expressed in parts by mass per 100 parts by mass of the rubber component).
a) Natural rubber (NR): trade name “RSS #3”
b) Carbon black: trade name “N339 Seast KH” (manufactured by TOKAI CARBON CO., LTD.)
c) Phosphoric acid-modified cellulose nanofiber: trade name “Cellulose nanofiber and natural rubber composite” (manufactured by Oji Holdings Corporation)
d) Zinc white: trade name “Zinc oxide grade 1” (manufactured by MITSUI MINING & SMELTING CO., LTD.)
e) Stearic acid: trade name “LUNAC S-20” (manufactured by Kao Corporation)
f) Sulfur: trade name “Powdered sulfur for rubber, 150 mesh” manufactured by Hosoi Chemical Industry Co., Ltd.
g) Vulcanization accelerator: trade name “NOCCELER CZ”, manufactured by OUCHI SHINKO CHEMICAL INDUSTRIAL CO., LTD.

TABLE 1

| | Comparative | | | | |
|---|---|---|---|---|---|
| | Example 1 | Example 1 | Example 2 | Example 3 | Example 4 |
| Natural rubber | 100 | 100 | 100 | 100 | 100 |
| Carbon black | 50 | 48 | 45 | 40 | 30 |
| Cellulose nanofiber | | 2 | 5 | 10 | 20 |
| Zinc white | 2 | 2 | 2 | 2 | 2 |
| Stearic acid | 2 | 2 | 2 | 2 | 2 |
| Sulfur | 1.5 | 1.5 | 1.5 | 1.5 | 1.5 |
| Vulcanization | 1.5 | 1.5 | 1.5 | 1.5 | 1.5 |
| accelerator | | | | | |
| Hardness degree | 100 | 102 | 104 | 110 | 111 |
| (INDEX) | | | | | |
| Stress at 100% | 100 | 120 | 134 | 164 | 201 |
| elongation (INDEX) | | | | | |
| Tensile product | 100 | 90 | 77 | 56 | 35 |
| (INDEX) | | | | | |

As can be seen from the results shown in Table 1, although the rubber compositions according to Examples 1 to 4 are obtained by dry-mixing cellulose nanofiber, a rubber component, and other compounding agents, dispersibility of the cellulose nanofiber is excellent and reinforcing effect is sufficiently exhibited so that the vulcanized rubbers thereof have improved moduli.

TABLE 2

| | Comparative | | | |
|---|---|---|---|---|
| | Example 2 | Example 5 | Example 6 | Example 7 |
| Natural rubber | 100 | 100 | 100 | 100 |
| Carbon black | 50 | 40 | 35 | 26 |
| Cellulose nanofiber | | 5 | 5 | 10 |
| Zinc white | 2 | 2 | 2 | 2 |
| Stearic acid | 2 | 2 | 2 | 2 |
| Sulfur | 1.5 | 1.5 | 1.5 | 1.5 |
| Vulcanization | 1.5 | 1.5 | 1.5 | 1.5 |
| accelerator | | | | |
| Hardness degree | 100 | 100 | 98 | 101 |
| (INDEX) | | | | |
| Stress at 100% | 100 | 125 | 117 | 144 |
| elongation (INDEX) | | | | |
| Tensile product | 100 | 107 | 116 | 109 |
| (INDEX) | | | | |

As can be seen from the results shown in Table 2, although the rubber compositions according to Examples 5 to 7 are obtained by dry-mixing cellulose nanofiber, a rubber component, and other compounding agents, dispersibility of the cellulose nanofiber is excellent and reinforcing effect is sufficiently exhibited so that the vulcanized rubbers thereof have improved moduli. In addition, it can be seen that the entire amounts of a filler added (total amounts of carbon black and cellulose nanofiber added) of the rubber compositions according to Examples 5 to 7 are reduced so that the vulcanized rubbers have improved tensile products.

What is claimed is:

1. A rubber composition for pneumatic tires comprising a diene-based rubber, carbon black, and phosphoric acid-modified cellulose nanofiber.

2. The rubber composition for pneumatic tires according to claim 1, wherein the cellulose nanofiber is contained in an amount of 0.1 to 50 parts by mass per 100 parts by mass of an entire amount of the diene-based rubber.

3. The rubber composition for pneumatic tires according to claim 1, wherein the carbon black is contained in an amount of 1 to 80 parts by mass per 100 parts by mass of an entire amount of the diene-based rubber.

4. The rubber composition for pneumatic tires according to claim 1, wherein when a content of the carbon black and a content of the cellulose nanofiber per 100 parts by mass of an entire amount of the diene-based rubber are respectively defined as X and Y, X+Y<80 and 0.05< (Y/(X+Y)<0.5 are satisfied.

5. A vulcanized rubber obtained by vulcanizing and molding the rubber composition for pneumatic tires according to claim 1.

6. A pneumatic tire comprising the vulcanized rubber according to claim 5 as a rubber part.
